(19) United States
(12) Patent Application Publication
(10) Pub. No.: US 2026/0260263 A1
(43) Pub. Date: Sep. 3, 2026

(54) SYSTEM AND METHOD FOR REAL-TIME OPTIMIZATION OF MARKETING CAMPAIGNS ACROSS MULTIPLE AD FORMATS USING REGENERATIVE ANALYTICS

(71) Applicant: Francis Kanneh, Santa Monica, CA (US)

(72) Inventor: Francis Kanneh, Santa Monica, CA (US)

(73) Assignee: Francis Kanneh, Santa Monica, CA (US)

(21) Appl. No.: 19/066,178

(22) Filed: Feb. 28, 2025

(51) Int. Cl. G06Q 30/0242; G06F 40/30; G06N 3/0475; G06Q 30/0251; G06T 11/60

(52) U.S. Cl. CPC G06Q 30/0244; G06N 3/0475; G06Q 30/0254; G06Q 30/0261; G06T 11/60; G06F 40/30

(57) ABSTRACT

Disclosed are a system and method for regenerative marketing analytics. The method includes a step of receiving digital creative data and ingesting historical performance data. The method includes a step of evaluating the digital creative data for underperformance using a performance metric. The method includes a step of generating optimized digital creative data using one or more of a set of generative adversarial networks (GANs), a set of diffusion models, and a set of video GANs. The method includes the step of deploying the optimized digital creative data alongside the original digital creative data for live campaign testing. The method includes the step of combining insight from textual data, visual data, and behavioral data to identify one or more underperforming live campaigns and generate optimized variations of the set of live campaigns. The method includes the step of identifying one or more high-risk campaigns and utilizes a historical performance data to flag the one or more high-risk campaigns based on the performance metric. The method includes a step of monitoring real-time performance data of live campaigns via one or more APIs.

### TECHNOLOGICAL FIELD

The present disclosure generally relates to a regenerative marketing analytics system and method for real-time campaign optimization and more particularly relates to a regenerative marketing analytics system for real-time campaign optimization across multiple advertisement (Ads) formats.

### BACKGROUND

The advent of digital advertising has transformed the marketing landscape, providing unprecedented opportunities for businesses to reach targeted audiences. However, existing marketing analytics systems are predominantly designed to offer post-campaign reporting, which, while valuable for retrospective analysis, fails to address the need for immediate corrective actions during active campaigns. This limitation significantly hampers a marketer's ability to optimize performance in real-time and maximize return on investment.

Moreover, the optimization processes in current systems often require extensive manual intervention. Marketers must manually identify underperforming campaigns, create new creative assets, and reallocate budgets. These tasks are time-intensive, prone to human error, and insufficiently scalable. The current systems lack robust automation capabilities for regenerating creative assets or dynamically reallocating resources in response to real-time performance data.

The complexity increases further due to the diverse range of digital advertising formats, including images, videos, and text-based ads, which require nuanced and format-specific optimization strategies. The absence of a unified, automated, and AI-driven approach to monitor, analyze, and optimize campaigns across these formats poses a significant challenge to marketers.

U.S. Pat. No. 10,887,640B2, issued to Viswanathan Swaminathan et al., discloses systems utilizing an artificial intelligence framework for generating enhanced digital content and improving the design of digital content campaigns. The disclosed systems employ a metadata neural network, a summarizer neural network, and/or a performance neural network to generate metadata for digital content, predict future performance metrics, produce enhanced digital content, and recommend content modifications to improve performance when disseminated to client devices. While this system addresses dynamic video and image regeneration using GANs and neural networks, it focuses primarily on enhancing content design rather than providing real-time campaign optimization across multiple channels.

Korean Patent KR102713995B1, filed by VM Insight, describes a user terminal equipped with a display unit for analyzing information related to multiple advertisers and presenting an artificial intelligence-based advertising platform that provides tailored advertising information to users. The system also includes a user input unit to gather user feedback. Although this invention focuses on advertiser matching and user customization, it does not incorporate generative AI capabilities for regenerating campaign elements or automating A/B testing.

US Patent Application US20190392487A1, filed by Steven Murray Duke et al., discloses a system for the automated creation of digital advertisements. The system includes an artificial intelligence unit configured to process digital copies of past advertisements, their performance data, brand guidelines, and a creative brief to generate new advertisement elements such as logos, headlines, sub-headlines, call-to-actions, legal content, and images. These elements are selected based on their correlation with superior past performance metrics that exceed a predefined threshold. The system further includes an automatic advertisement generation unit that assembles these elements onto a canvas to create a new advertisement. Additionally, it supports real-time, user-specific advertisement customization based on historical performance data for the same advertiser. However, this system is limited to ad creation through an assembly of elements and does not address real-time regeneration, predictive failure analysis, or dynamic optimization across campaigns.

There is a need to address these challenges by providing a regenerative marketing analytics system capable of monitoring campaign performance, analyzing underperforming elements, and regenerating optimized creative assets automatically.

Further limitations and disadvantages of conventional approaches will become apparent to one of skill in the art through the comparison of described systems with some aspects of the present disclosure, as outlined in the remainder of the present application and with reference to the drawings.

### BRIEF SUMMARY OF SOME EXAMPLE EMBODIMENTS

In order to solve the foregoing problem, the present disclosure may provide a regenerative marketing analytics system for real-time campaign optimization across multiple advertisement (Ads) formats.

In one aspect, a regenerative marketing analytics system is provided. The system includes a memory and a computer processor. The memory is configured for storing program instructions and the computer processor is coupled to the memory and executing the program instructions. The memory includes a creative upload and data ingestion module, a creative analysis module, a content regeneration engine module, a testing deployment module, a multimodal generative module, a predictive failure analysis module, and a feedback loop and performance tracking module. The creative upload and data ingestion module is configured to receive digital creative data and ingest historical performance data. The creative analysis module is configured to evaluate the digital creative data for underperformance using a performance metric. The content regeneration engine module is configured to generate optimized digital creative data using one or more of a set of generative adversarial networks (GANs), a set of diffusion models, and a set of video GANs. The testing deployment module is configured to deploy generated digital creative data alongside original digital creative data for live campaign testing. The testing deployment module is configured to integrate with a set of external advertising platforms via one or more APIs for campaign deployment. The multimodal generative module is configured to combine insight from textual data, visual data, and behavioral data to identify one or more underperforming live campaigns and generate optimized variations of the set of live campaigns. The predictive failure analysis module is configured to identify one or more high-risk campaigns and utilizes a historical performance data to flag the one or more high-risk campaigns based on the performance metric. The feedback loop and performance tracking module is configured to monitor the real-time performance data of a set of live campaigns via the one or more APIs.

In additional system embodiments, the feedback loop and performance tracking module is configured to identify trends in live campaign data and update a set of generative models to enhance future creative outputs.

In additional system embodiments, the testing deployment module is configured to compute a statistical significance of campaign results to determine the performance of regenerated content relative to original content.

In additional system embodiments, the creative analysis module is further configured to analyze emotional tone based on a set of natural language processing algorithms.

In additional system embodiments, the set of generative models of the content regeneration engine module incorporates multi-modal learning to simultaneously optimize visual and textual elements.

In additional system embodiments, the content regeneration engine module applies diffusion models to improve video backgrounds while preserving the original video subject.

In additional system embodiments, the creative analysis module is configured to prioritize one or more high-return on investment (ROI) campaigns for regeneration and to generate region-specific creatives comprising localized visuals, text, and cultural preferences.

In additional system embodiments, the content regeneration engine module is configured to generate localized variations of regenerated advertisements tailored for different regional markets.

In additional system embodiments, the content regeneration engine module is configured to provide personalized asset regeneration based on historical seasonal trends and to dynamically adjust campaigns accordingly.

In additional system embodiments, the content regeneration engine module is configured to aggregate seasonal trends to optimize the timing and engagement of the set of live campaigns.

In yet another aspect, a computer-implemented method for regenerative marketing analytics is provided. The method includes a step of receiving, by a computer, digital creative data and ingesting historical performance data. The method includes a step of evaluating, by the computer, the digital creative data for underperformance using a performance metric. The method includes a step of generating, by the computer, optimized digital creative data using one or more of a set of generative adversarial networks (GANs), a set of diffusion models, and a set of video GANs. The method includes a step of deploying, by the computer, the optimized digital creative data alongside the original digital creative data for live campaign testing. The method includes a step of combining, by the computer, insight from textual data, visual data, and behavioral data to identify one or more underperforming live campaigns and generate optimized variations of the set of live campaigns. The method includes a step of identifying, by the computer, one or more high-risk campaigns and utilizes a historical performance data to flag the one or more high-risk campaigns based on the performance metric. The method includes a step of monitoring, by the computer, real-time performance data of live campaigns via one or more APIs.

In additional method embodiments, the method includes a step of identifying, by the computer, trends in live campaign data and updating the set of generative models to enhance future creative outputs.

In additional method embodiments, the method includes a step of computing, by the computer, a statistical significance of campaign results to determine the performance of regenerated digital creative data relative to the original digital creative data.

In additional method embodiments, the method includes a step of analyzing, by the computer, emotional tone within the digital creative data using a set of natural language processing algorithms.

In additional method embodiments, the method includes a step of optimizing, by the computer, both visual and textual elements of the digital creative data using multi-modal learning techniques in the set of generative models.

In additional method embodiments, the method includes a step of improving, by the computer, video backgrounds while preserving the original video subject using diffusion models.

In additional method embodiments, the method includes a step of prioritizing, by the computer, one or more high-return on investment (ROI) campaigns for regeneration and generating region-specific creatives comprising localized visuals, text, and cultural preferences.

In additional method embodiments, the method includes a step of generating, by the computer, localized variations of regenerated advertisements tailored for different regional markets.

In additional method embodiments, the method includes a step of providing, by the computer, personalized asset regeneration based on historical seasonal trends and dynamically adjusting campaigns accordingly.

In additional method embodiments, the method includes a step of aggregating, by the computer, seasonal trends to optimize the timing and engagement of the set of live campaigns.

In yet another aspect, a computer program product for regenerative marketing analytics is provided. The computer program product includes one or more computer-readable storage media; and program instructions stored on the one or more computer-readable storage media to perform operations comprising: receiving digital creative data and ingesting historical performance data; evaluating the digital creative data for underperformance using a performance metric; generating optimized digital creative data using one or more of a set of generative adversarial networks (GANs), a set of diffusion models, and a set of video GANs; deploying the optimized digital creative data alongside the original digital creative data for live campaign testing; combining insight from textual data, visual data, behavioral data to identify one or more underperforming live campaigns and generate optimized variations of the set of live campaigns; identifying one or more high-risk campaigns and utilizes a historical performance data to flag the one or more high-risk campaigns based on the performance metric and monitoring real-time performance data of live campaigns via one or more APIs.

Accordingly, one advantage of the present invention is that it provides marketers with actionable insights and automated solutions to optimize campaigns dynamically across all major digital advertising formats by leveraging AI technologies, such as generative adversarial networks (GANs), diffusion models, and video GANs.

Accordingly, one advantage of the present invention is that it eliminates the reliance on post-campaign analysis and manual intervention, empowering marketers to achieve superior results with reduced effort and time investment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a regenerative marketing analytics system for real-time campaign optimization, in accordance with one or more example embodiments.

FIG. 2A illustrates an exemplary block diagram of the system, in accordance with one or more example embodiments.

FIG. 2B illustrates an operational flow diagram of the regenerative marketing analytics system, in accordance with one or more example embodiments.

FIG. 3 illustrates a flowchart of a computer-implemented method for regenerative marketing analytics, in accordance with one or more example embodiments.

FIG. 4 illustrates a before-and-after image of regenerated creatives based on dataset insights, in accordance with one or more example embodiments.

FIG. 5 illustrates an image of incremental brightness changes, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the description and should not be regarded as limiting. Any heading utilized within this description is for convenience only and has no legal or limiting effect.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

A system, a method, and a computer program product are provided for real-time campaign optimization across multiple advertisement formats including search ads, display ads, video ads, social media ads, and email marketing. The system and method of the proposed invention address inefficiencies in traditional marketing analytics by offering real-time performance monitoring and optimization capabilities. The system identifies underperforming campaign elements such as visuals, text, targeting strategies, and platform allocation and applies automated solutions to improve campaign outcomes.

One of the objectives of the present system includes real-time monitoring, which continuously tracks campaign performance metrics to provide actionable insights, and performance analysis, which detects underperforming elements across creative, targeting, and channel allocations. Additionally, the system incorporates creative asset regeneration, automatically generating optimized creative assets, such as updated visuals and rewritten ad copy, using machine learning techniques. Automated A/B testing is also integrated, enabling the execution and evaluation of optimized ad variations to identify the most effective combinations. Furthermore, the system offers dynamic budget reallocation, shifting budgets to high-performing channels and campaigns to maximize return on investment (ROI). Its multi-format integration supports various advertising formats, allowing seamless optimization across search, banner, video, social media, and email campaigns.

The present system and method further leverage machine learning to continuously learn from campaign performance data, enhancing the precision and relevance of its recommendations over time. This adaptive capability ensures efficient utilization of marketing resources, reduces wasted ad spend, and maximizes ROI through automated and AI-driven continuous improvement. Overall, this invention represents a significant advancement in marketing technology, enabling marketers to achieve superior campaign performance with reduced manual effort and improved resource allocation.

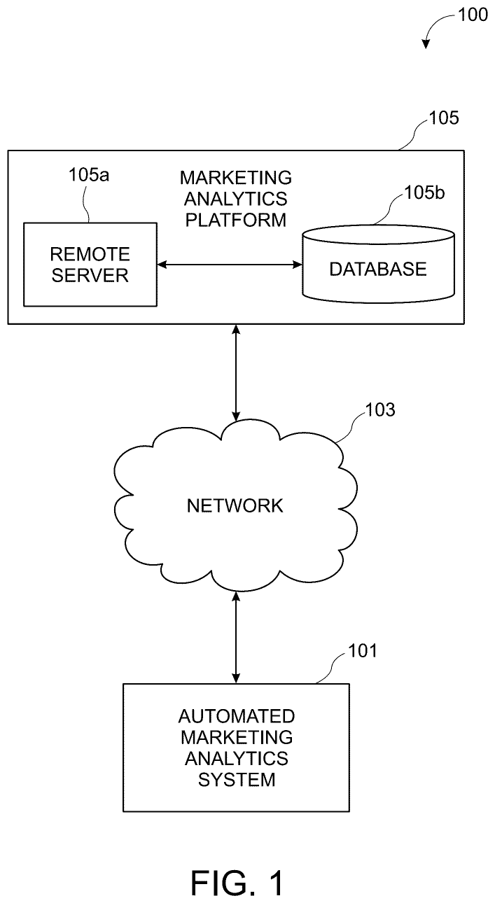

FIG. 1 illustrates a block diagram 100 showing an example architecture of a regenerative marketing analytics system 101 for real-time campaign optimization, in accordance with one or more example embodiments. As illustrated in FIG. 1, the block diagram 100 may comprise the system 101, a network 103, and a marketing analytics platform 105. The marketing analytics platform 105 includes a remote server 105a, and a database 105b. In an embodiment, the digital creative data or digital creative content is uploaded by marketers either on the remote server 105a. Example of digital creative data includes images, videos, and text. The components described in the block diagram 100 may be further broken down into more than one component such as one or more modules or applications and/or combined in any suitable arrangement. Further, it is possible that one or more components may be rearranged, changed, added, and/or removed without deviating from the scope of the present disclosure.

In various embodiments, the remote server 105a may receive the data from various data sources such as online channels, offline channels, social media, and CRM systems over the network 103. For example, the regenerative marketing analytics system 101 may be embodied as a cloud-based service, a cloud-based application, a cloud-based platform, a remote server-based service, a remote server-based application, a remote server-based platform, or a virtual computing system. In each of such embodiments, the regenerative marketing analytics system 101 may be communicatively coupled to the components shown in FIG. 1 to carry out the desired operations and wherever required modifications may be possible within the scope of the present disclosure.

In various embodiments, the regenerative marketing analytics system 101, database 105b, and the remote server 105a are connected over the network 103 for data transmission. The network 103 may be wired, wireless, or any combination of wired and wireless communication networks, such as cellular, Wi-Fi, internet, local area networks, or the like. In some embodiments, network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The database 105b may include data received from the online channels, offline channels, social media, and CRM systems. The database 105b may be communicatively coupled to the remote server 105a. The remote server 105a may comprise one or more processors configured to process requests received from the regenerative marketing analytics system 101. The processor may fetch data from the database 105b and transmit the same to the regenerative marketing analytics system 101 in a format suitable for use by system 101.

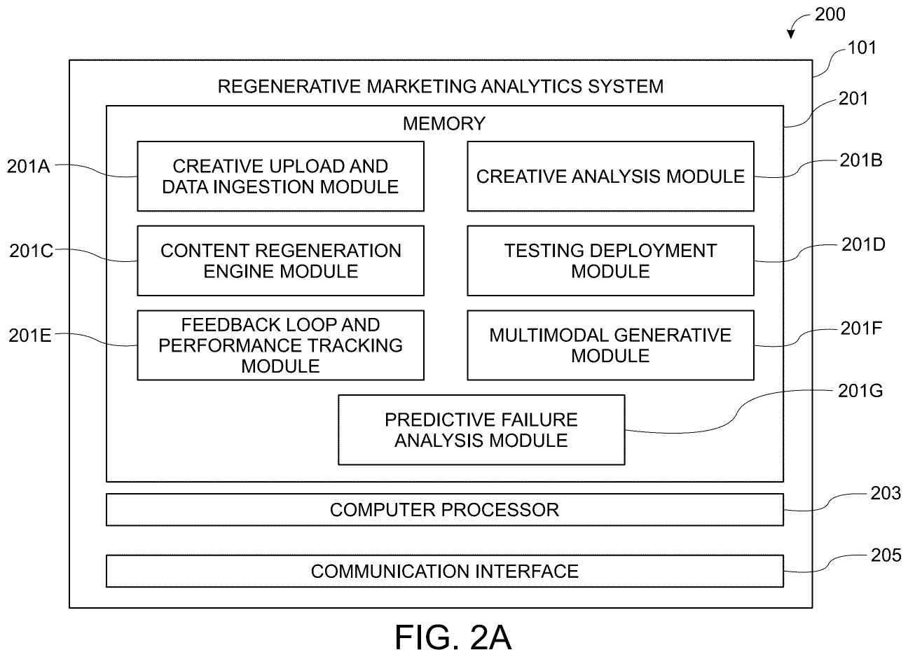

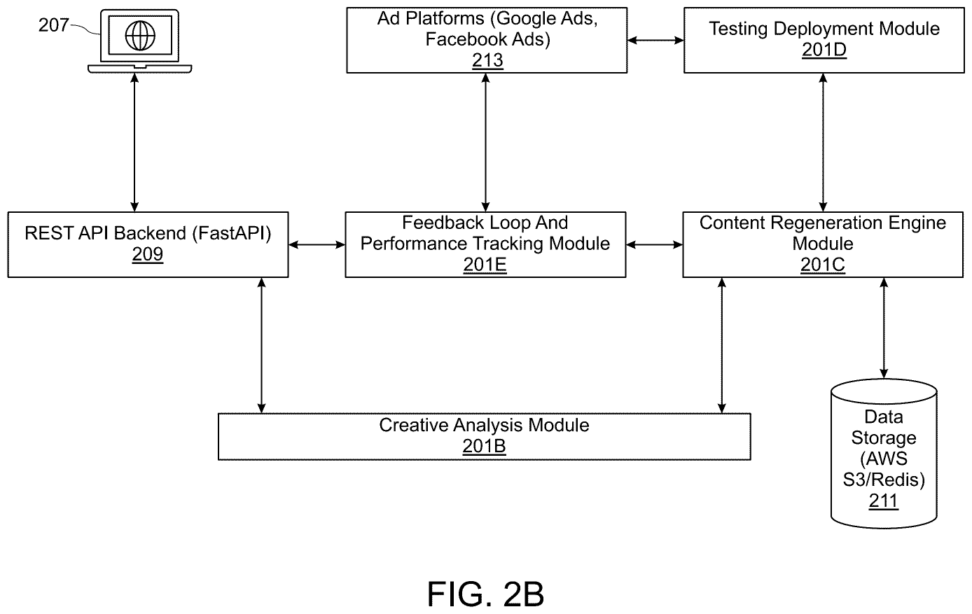

FIG. 2A illustrates an exemplary block diagram 200 of the regenerative marketing analytics system 101, in accordance with one or more example embodiments. FIG. 2 is explained in conjunction with FIG. 1. The regenerative marketing analytics system 101 includes a memory 201, a computer processor 203, and a communication interface 205. Memory 201 is configured for storing program instructions. In an embodiment, the memory 201 is further configured for storing a creative upload and data ingestion module 201A, a creative analysis module 201B, a content regeneration engine module 201C, a testing deployment module 201D, a feedback loop and performance tracking module 201E, a multimodal generative module 201F, and a predictive failure analysis module 201G. The computer processor 203 is coupled to the memory 201 and executes the program instructions for executing a method for regenerative marketing analytics, wherein the marketing data is obtained from the remote server 105a. The remote server 105a is configured to receive the data from various data sources. Examples of the data sources include but are not limited to online channels, offline channels (e.g. TV, radio, print media), social media platforms (e.g. Twitter, Instagram, YouTube), Customer Relationship Management (CRM) systems (e.g. Salesforce, HubSpot), Digital Marketing Platforms (e.g. Google Ads, Facebook Ads, LinkedIn Ads), e-commerce platforms (e.g. Shopify, WooCommerce), and email marketing tools (e.g. Mailchimp, SendGrid). The marketing data and analytics data are stored in a database 105b associated with the marketing analytics platform 105. In an embodiment, the creative upload and data ingestion module 201A is configured to receive digital creative data and ingest historical performance data. In an embodiment, the historical performance data comprising click-through rates (CTR) and return on investment (ROI), via one or more APIs or file uploads.

The creative analysis module 201B is configured to evaluate the digital creative data for underperformance using a performance metric. The performance metric includes CTR and conversion rates. The creative analysis module 201B is configured to perform visual analysis on images and videos, including brightness levels and layout structure. The creative analysis module 201B is configured to perform text analysis on text-based content, including emotional tone and readability. In additional system embodiments, the creative analysis module 201B is further configured to analyze emotional tone based on a set of natural language processing algorithms. The creative analysis module 201B prioritizes one or more high-return on investment (ROI) campaigns for regeneration and generates region-specific creatives comprising localized visuals, text, and cultural preferences.

The content regeneration engine module 201C is configured to generate optimized digital creative data using one or more of a set of generative adversarial networks (GANs), a set of diffusion models, and a set of video GANs. In an embodiment, Generative Adversarial Networks (GANs) are used to regenerate underperforming banner ads, ensuring they remain engaging and effective. By leveraging adversarial training, GANs may enhance product-focused images, improving clarity and visual appeal. This is particularly useful in e-commerce and digital advertising, where high-quality imagery significantly influences customer engagement. Additionally, GANs of the present system may generate image variations tailored for specific demographic groups, such as younger audiences, by adjusting color schemes, design elements, and subject focus based on audience preferences. In video marketing, GANs optimize pacing, visuals, and text overlays to improve engagement. By analyzing real-time performance data, GANs can adjust video elements dynamically, ensuring that content remains relevant to viewers. Video GANs, an extension of GANs, apply style transfer techniques to enhance video aesthetics while preserving brand identity. This allows brands to maintain a consistent visual theme across multiple campaigns while adapting content to different regions, demographics, and cultural preferences. Further, diffusion models provide an advanced approach to refining ad visuals by progressively enhancing images and videos through a noise-removal process. These models begin with a noise-filled version of an image or video and iteratively refine it, resulting in highly detailed and realistic outputs. This is particularly beneficial for video ad backgrounds, where diffusion models can subtly improve elements such as lighting, focus, and branding without altering the core message of the advertisement. By utilizing an iterative noise-removal approach, diffusion models enable the creation of multiple variations of ad visuals. This allows marketers to experiment with different styles, backgrounds, and branding elements to determine the most effective creative assets. For instance, a plain white background in an ad can be transformed into a high-contrast image featuring a customer holding the product, creating a more engaging and relatable visual experience.

Additionally, GANs and diffusion models contribute to real-time ad personalization and optimization. By continuously analyzing audience engagement data, these AI-driven models dynamically adjust advertising elements to enhance user experience and improve campaign performance. Whether it is refining banner ads, generating region-specific video styles, or enhancing image quality, these AI techniques ensure that marketing campaigns remain relevant, visually appealing, and highly targeted. By integrating GANs, Video GANs, and diffusion models into a regenerative marketing analytics system, brands can achieve a new level of creative efficiency and audience engagement. These technologies not only enhance the quality of visual content but also enable real-time adaptability, ensuring that advertising remains impactful across diverse consumer segments.

The content regeneration engine module 201C is configured to modify images by adjusting at least one of the brightness, background elements, or composition. The content regeneration engine module 201C is configured to improve text overlays by enhancing readability or emotional tone. The content regeneration engine module 201C is configured to modify video content by shortening or polishing sequences. In additional system embodiments, the set of generative models of the content regeneration engine module 201C incorporates multi-modal learning to simultaneously optimize visual and textual elements. In additional system embodiments, the content regeneration engine module 201C applies diffusion models to improve video backgrounds while preserving the original video subject. The content regeneration engine module 201C utilizes a set of machine learning models trained on historical performance data to predict creative modifications for improved campaign performance. The content regeneration engine module 201C is configured to generate localized variations of regenerated advertisements tailored for different regional markets. The content regeneration engine module 201C is configured to provide personalized asset regeneration based on historical seasonal trends and to dynamically adjust campaigns accordingly. The content regeneration engine module 201C is configured to aggregate seasonal trends to optimize the timing and engagement of the set of live campaigns. The below table briefly explains the marketing campaign performance dataset that provides valuable insights into the effectiveness of various marketing campaigns. This dataset captures the performance metrics, target audience, duration, channels used, and other essential factors that contribute to the success of marketing initiatives. This dataset offers a comprehensive view of campaign performance across diverse companies and customer segments.

The dataset provides insights into the effectiveness of various marketing campaigns run by different companies over a given period. It includes key performance indicators such as conversion rates, acquisition costs, engagement scores, and return on investment (ROI). This information helps assess which strategies work best across different audience segments, channels, and geographic locations.

The dataset showcases a wide range of marketing strategies, including email marketing, social media advertising, influencer marketing, display ads, and search campaigns. These campaigns are designed to engage specific customer segments such as Tech Enthusiasts, Health & Wellness consumers, Foodies, and Fashionistas. By analyzing the effectiveness of these strategies, businesses can determine which methods generate the best results.

The data also highlights performance variations across different marketing channels. Platforms such as Google Ads, YouTube, and Facebook are widely used, while Instagram and company websites also play significant roles. Notably, email marketing tends to have relatively high conversion rates (e.g., 0.12) compared to display ads (0.04), suggesting that direct communication via email remains an effective tool for customer engagement.

Demographic targeting and language preferences also play a crucial role in marketing success. Campaigns in the dataset focus on specific age groups such as Men 25-34 or Women 35-44, and they are conducted in multiple languages, including English, Spanish, French, German, and Mandarin. This highlights the importance of language and cultural preferences in audience engagement.

A significant factor in campaign evaluation is cost and return on investment. Acquisition costs vary widely, with some campaigns exceeding $17,000, while others are conducted at a much lower cost. ROI figures range from 2.86 to 7.18, indicating that some campaigns are more profitable than others. Understanding these variations helps businesses allocate their marketing budgets more effectively.

Engagement trends further illustrate campaign effectiveness. The engagement score, measured on a scale of 1 to 10, provides insight into how well a campaign resonates with its audience. Interestingly, some campaigns with high impressions (e.g., 9000+) do not always translate into high engagement, suggesting that visibility alone does not guarantee interaction.

Geographic impact is another critical aspect of the dataset. Major cities such as New York, Los Angeles, Chicago, Houston, and Miami are key target locations. Campaigns may perform differently depending on regional preferences, emphasizing the need for location-based marketing strategies.

Each column in the dataset represents a key factor in campaign analysis. The Company column identifies the organization running the campaign, while the Campaign Type describes the approach used, such as email, social media, influencer marketing, or display ads. The Target Audience specifies the demographic group targeted, such as Men 18-24 or Women 35-44. The Duration indicates how long the campaign ran, ranging from 15 to 60 days.

The Channel used refers to the platform through which the campaign was conducted, such as Google Ads, YouTube, or Instagram. The Conversion Rate measures the percentage of impressions that led to a desired action, providing a key metric for campaign effectiveness. The Acquisition Cost represents the total expenditure to acquire customers through the campaign, while the ROI (Return on Investment) indicates profitability.

Geographical factors are captured in the Location column, identifying where the campaign was executed. The Language column specifies the primary language used in the campaign, highlighting its relevance for audience targeting. The Clicks and Impressions columns measure the number of user interactions and the total views of the campaign, respectively. The Engagement Score provides a numerical rating of audience interaction, ranging from 1 to 10.

Lastly, the Customer Segment categorizes the type of audience targeted, such as Fashionistas, Foodies, or Tech Enthusiasts. The Date column records when each campaign was conducted, allowing for chronological trend analysis.

| Campaign_{—} | | Campaign_{—} | Target_{—} | | Channel_{—} | Conversion_{—} | Acquisition_{—} | | |
|---|---|---|---|---|---|---|---|---|---|
| ID | Company | Type | Audience | Duration | Used | Rate | Cost | ROI | Location |
| 1 | Innovate industries | Email | Men 18-2 [symbol] | 30 days | Google Ads | 0.04 | $16,174.00 | 6.29 | Chicago |
| 2 | NexGen Systems | Email | Women 3 [symbol] | 60 days | Google Ads | 0.12 | $11,566.00 | 5.61 | New York |
| 3 | Alpha innovations | Influencer | Men 25-3 [symbol] | 30 days | YouTube | 0.07 | $10,200.00 | 7.19 | Los Angel [symbol] |
| 4 | DataTech Solutions | Display | All Ages | 60 days | YouTube | 0.11 | $12,724.00 | 5.55 | Miami |
| 5 | NexGen Systems | Email | Men 25-3 [symbol] | 15 days | YouTube | 0.05 | $16,452.00 | 6.5 | Los Angel [symbol] |
| 6 | DataTech Solutions | Display | All Ages | 15 days | Instagram | 0.07 | $9,716.00 | 4.36 | New York |
| 7 | NexGen Systems | Email | Women 3 [symbol] | 60 days | Website | 0.13 | $11,057.00 | 2.86 | Los Angel [symbol] |
| 8 | DataTech Solutions | Search | Men 18-2 [symbol] | 45 days | Google Ads | 0.08 | $13,280.00 | 5.55 | Los Angel [symbol] |
| 9 | Alpha innovations | Social Med [symbol] | Women 3 [symbol] | 15 days | Facebook | 0.09 | $18,056.00 | 6.73 | Chicago |
| 10 | TechCorp | Email | Women 3 [symbol] | 15 days | Instagram | 0.09 | $13,766.00 | 3.78 | Los Angel [symbol] |
| 11 | NexGen Systems | Display | Men 25-3 [symbol] | 45 days | Email | 0.12 | $8,590.00 | 3.49 | New York |
| 12 | Innovate industries | Influencer | Men 25-3 [symbol] | 60 days | Google Ads | 0.05 | $17,502.00 | 3.59 | Los Angel [symbol] |
| 13 | TechCorp | Social Med [symbol] | Men 25-3 [symbol] | 60 days | Facebook | 0.09 | $17,189.00 | 4.91 | Chicago |
| 14 | TechCorp | Email | Men 25-3 [symbol] | 45 days | Instagram | 0.14 | $9,975.00 | 7.06 | New York |
| 15 | TechCorp | Display | All Ages | 45 days | Website | 0.04 | $11,346.00 | 5.28 | Chicago |
| 16 | Innovate industries | Social Med [symbol] | Women 3 [symbol] | 60 days | YouTube | 0.11 | $9,407.00 | 2.91 | New York |
| 17 | Innovate industries | Display | Women 3 [symbol] | 45 days | Website | 0.08 | $5,478.00 | 4.53 | Houston |
| 18 | Alpha innovations | Influencer | Men 18-2 [symbol] | 15 days | Instagram | 0.14 | $9,485.00 | 4.48 | Miami |
| 19 | Alpha innovations | Social Med [symbol] | Men 25-3 [symbol] | 60 days | Google Ads | 0.07 | $19,224.00 | 6.08 | New York |
| 20 | DataTech Solutions | Influencer | Men 25-3 [symbol] | 15 days | Google Ads | 0.09 | $10,258.00 | 3.33 | Miami |

| Campaign_{—} | | | | Engagement_{—} | Customer_{—} | |
|---|---|---|---|---|---|---|
| ID | Language | Clicks | impressions | Score | Segment | Date |
| 1 | Spanish | 506 | 1 [symbol] 22 | 6 | Health & Wellness | 1 Jan. 2021 |
| 2 | German | 116 | 7523 | 7 | Fashionistas | 2 Jan. 2021 |
| 3 | French | 584 | 7698 | 1 | Outdoor Adventurers | 3 Jan. 2021 |
| 4 | Mandarin | 217 | 1820 | 7 | Health & Wellness | 4 Jan. 2021 |
| 5 | Mandarin | 379 | 4201 | 3 | Health & Wellness | 5 Jan. 2021 |
| 6 | German | 100 | 1643 | 1 | Foodies | 6 Jan. 2021 |
| 7 | Spanish | 817 | [symbol] 749 | 10 | Tech Enthusiasts | 7 Jan. 2021 |
| 8 | Mandarin | 624 | 7854 | 7 | Outdoor Adventurers | 8 Jan. 2021 |
| 9 | German | 861 | 1754 | 6 | Tech Enthusiasts | 9 Jan. 2021 |
| 10 | English | 642 | 3856 | 3 | Tech Enthusiasts | 10 Jan. 2021 |
| 11 | Spanish | 321 | 6628 | 10 | Tech Enthusiasts | 11 Jan. 2021 |
| 12 | Mandarin | 659 | 8548 | 1 | Foodies | 12 Jan. 2021 |
| 13 | Mandarin | 677 | 8 [symbol] 17 | 10 | Tech Enthusiasts | 13 Jan. 2021 |
| 14 | German | 594 | 2201 | 4 | Health & Wellness | 14 Jan. 2021 |
| 15 | Spanish | 482 | 8470 | 1 | Outdoor Adventurers | 15 Jan. 2021 |
| 16 | German | 299 | 1512 | 5 | Health & Wellness | 16 Jan. 2021 |
| 17 | English | 531 | 2488 | 3 | Fashionistas | 17 Jan. 2021 |
| 18 | French | 218 | 9264 | 3 | Health & Wellness | 18 Jan. 2021 |
| 19 | French | 182 | 5798 | 1 | Foodies | 19 Jan. 2021 |
| 20 | French | 1 [symbol] 3 | 3677 | 1 | Tech Enthusiasts | 20 Jan. 2021 |

[symbol]

indicates data missing or illegible when filed

The content regeneration engine module 201C is configured to predict creative modifications for improved campaign performance. The below table depicts a dataset that simulates advertising campaign data used for optimizing content distribution strategies. It provides user-level engagement data, enabling detailed insights into how different advertisements perform across various demographic and behavioral attributes. The dataset is particularly designed for use with evolutionary algorithms, such as the Shuffled Frog Leaping Algorithm with Dueling Deep Q-Networks, to refine ad dissemination strategies. The goal is to enhance user engagement and maximize return on investment (ROI).

The primary target column, ROI_Category, classifies campaigns into three categories: Low, Medium, and High, based on the effectiveness of ad spending in generating conversions. Most entries in the provided dataset fall into the Low ROI category, indicating areas where optimization is required in terms of targeting, cost per click, and engagement strategies.

Each row in the dataset represents an individual ad interaction, tracked using a unique user_id. The timestamp records the exact date and time of interaction. The dataset captures engagement across different device types (Mobile, Desktop, Tablet) and locations (USA, UK, India, Germany, etc.), allowing marketers to assess how ad performance varies by region and platform.

Users are categorized into age groups (e.g., 18-24, 35-44) and genders (Male/Female), which help advertisers tailor content to specific audiences. Each ad is identified using an ad_id and is classified by content type (Text, Image, Video) and ad topic (Fashion, Health, Automotive, Electronics, etc.). The ad_target_audience field specifies the intended consumer segment, such as Young Adults, Fitness Lovers, Family Oriented, or Travel Lovers.

Performance metrics include click-through rate (CTR), which measures how often users click on the ad, and conversion rate, which indicates the percentage of clicks that result in a desired action (e.g., purchase or sign-up). Engagement level captures user interactions—whether they Liked, Shared, Commented, or Ignored the ad. The view time metric helps gauge how long users engage with the ad content, while cost per click (CPC) reflects the advertising expense for each interaction. Some key observations are: 1) Video ads tend to generate higher engagement levels (Liked, Shared, Commented) but do not always result in higher conversion rates; 2) Young adults (18-24) and specific interest-based groups like Travel Lovers and Fitness Enthusiasts show varying levels of ad engagement; 3) Mobile users make up a significant portion of the data, with ad performance differing across regions such as the USA, UK, Germany, and India; and 4) Most campaigns fall into the Low ROI category, highlighting potential areas for refining ad placement, audience targeting, and cost efficiency.

| | | | | | | | | | | click_{—} |
|---|---|---|---|---|---|---|---|---|---|---|
| | | device_{—} | | age_{—} | | | content_{—} | ad_{—} | ad_target_{—} | through_{—} |
| user_id | timestamp | type | location | group | gender | ad_id | type | topic | audience | rate |
| 184 | 21-12-2025 23:32 | Desktop | USA | 55+ | Female | A3604 | Text | Health | Young Adults | 0.069629 |
| 425 | 18-12-2025 18:29 | Desktop | UK | 35-44 | Female | A4649 | Image | Fashion | Family Oriented | 0.043579 |
| 919 | 18-08-2025 04:50 | Mobile | Germany | 45-54 | Male | A6448 | Video | Automot [symbol] | Travel Lovers | 0.03842 |
| 335 | 28-01-2025 18:24 | Mobile | Canada | 55+ | Male | A19 [symbol] | Image | Fashion | Young Adults | 0.043683 |
| 607 | 17-112025 23:07 | Mobile | Canada | 45-54 | Male | A5216 | Video | Electronic | Family Oriented | 0.042209 |
| [symbol] 31 | 05-08-2025 13:23 | Mobile | India | 35+ | Female | A2877 | Text | Travel | Travel Lovers | 0.054023 |
| 188 | 05-05-2025 16:30 | Tablet | Germany | 35-44 | Male | A [symbol] | Image | Travel | Family Oriented | 0.016342 |
| 929 | 09-11-2025 07:15 | Desktop | Canada | 19-24 | Male | A5984 | Video | Automot [symbol] | Family Oriented | 0.120168 |
| [symbol] | 24-08-2025 15:59 | Tablet | Canada | 35-44 | Female | A4874 | Video | Electronic | Fitness Lovers | 0.054085 |
| 695 | 10-06-2025 22:00 | Desktop | USA | 25-34 | Female | A9247 | Image | Fashion | Travel Lovers | 0.119247 |
| 217 | 20-06-2025 02:15 | Mobile | UK | 35-44 | Female | A9531 | Video | Health | Fitness Lovers | 0.111564 |
| 46 [symbol] | 26-08-2025 02:53 | Desktop | India | 45-54 | Male | A4969 | Video | Automot [symbol] | Young Adults | 0.053715 |
| 581 | 05-11-2025 09:32 | Mobile | USA | 55+ | Male | A7990 | Text | Automot [symbol] | Young Adults | 0.054718 |
| 783 | 02-04-2025 23:09 | Desktop | USA | 45-54 | Male | A2047 | Image | Health | Travel Lovers | 0.093966 |
| [symbol] 84 | 19-11-2025 23:14 | Mobile | Germany | 45-54 | Male | A7566 | Text | Electronic | Fitness Lovers | 0.02643 |
| 765 | 12-07-2025 12:45 | Desktop | UK | 35-44 | Male | A2136 | Video | Fashion | Fitness Lovers | 0.032931 |
| 810 | 14-04-2025 01:36 | Mobile | UK | 45-54 | Female | A6418 | Text | Automot [symbol] | Travel Lovers | 0.026709 |
| 744 | 25-06-2025 14:35 | Desktop | Canada | 25-34 | Female | A1938 | Image | Electronic | Travel Lovers | 0.053 [symbol] |
| 952 | 02-02-2025 03:37 | Desktop | India | 35-44 | Female | A9613 | Video | Fashion | Travel Lovers | 0.067478 |
| 282 | 03-08-2025 18:55 | Mobile | Germany | 45-54 | Female | A1 [symbol] | Text | Electronic | Family Oriented | 0.045625 |
| 689 | 02-06-2025 08:39 | Mobile | India | 45-54 | Female | A7637 | Text | Automot [symbol] | Travel Lovers | 0.131 [symbol] |
| 772 | 28-07-2025 10:29 | Mobile | USA | 18-24 | Male | A [symbol] 806 | Text | Electronic | Young Adults | 0.126615 |

| | | | | cost_{—} | click | | |
|---|---|---|---|---|---|---|---|
| | conversion_{—} | engagement_{—} | view_{—} | per_{—} | through_{—} | conversion_{—} | ROI_{—} |
| user_id | rate | level | time | click | rate | rate | Category |
| 184 | 0.0366 | Liked | 32 | 1.09 | 0.069629 | 0.0366 | Low |
| 425 | 0.1482 | Comment | 12 | 1.09 | 0.043579 | 0.14 [symbol] | Low |
| 919 | 0.0742 | Comment | 16 | 0.97 | 0.03842 | 0.0742 | Low |
| 335 | 0.059 | Comment | 14 | 0.53 | 0.043683 | 0.059 | Low |
| 607 | 0.1042 | Liked | 42 | 0.59 | 0.042209 | 0.1042 | Low |
| [symbol] 31 | 0.0248 | Shared | 49 | 1.09 | 0.054023 | 0.0248 | Low |
| 188 | 0.0735 | Shared | 47 | 0.96 | 0.016342 | 0.07 [symbol] | Low |
| 929 | 0.0955 | Liked | 60 | 1.35 | 0.120168 | 0.0955 | Low |
| [symbol] | 0.086 | Shared | 46 | 1.31 | 0.054085 | 0.086 | Low |
| 695 | 0.0387 | Shared | 40 | 1.24 | 0.119247 | 0.0397 | Low |
| 217 | 0.0731 | Ignored | 31 | 0.51 | 0.111564 | 0.073 [symbol] | Low |
| 46 [symbol] | 0.1193 | Comment | 35 | 1.37 | 0.053725 | 0.1193 | Low |
| 581 | 0.1021 | Shared | 24 | 0.63 | 0.054719 | 0.1023 | Low |
| 783 | 0.0947 | Ignored | 37 | 0.34 | 0.093966 | 0.0947 | Low |
| [symbol] 84 | 0.0555 | Liked | 44 | 0.55 | 0.02643 | 0.0555 | Low |
| 765 | 0.0 [symbol] | Ignored | 35 | 1.05 | 0.032331 | 0.0833 | Low |
| 810 | 0.0941 | Ignored | 24 | 0.33 | 0.026709 | 0.941 | Low |
| 744 | 0.0718 | Comment | 55 | 0.94 | 0.053 [symbol] | 0.0718 | Low |
| 952 | 0.0874 | Comment | 57 | 0.11 | 0.067478 | 0.0874 | Low |
| 282 | 0.136 [symbol] | Liked | 14 | 0.23 | 0.045625 | 0.1383 | Low |
| 689 | 0.0167 | Comment | 59 | 1.14 | 0.131 [symbol] | 0.0167 | Low |
| 772 | 0.0773 | Liked | 31 | 0.23 | 0.126615 | 0.0778 | Low |

[symbol]

indicates data missing or illegible when filed

The regenerative marketing analytics system 101 is used for real-time campaign optimization. The dataset shown in the below table provides insights into advertising campaign optimization and retail sales performance. It combines user-level engagement metrics from digital advertising with sales data, enabling the development of data-driven strategies for enhancing return on investment (ROI) and user engagement. The advertising campaign dataset focuses on user interactions with advertisements, capturing demographic and behavioral attributes that influence ad performance. It includes details such as device type, location, age group, gender, and engagement metrics like click-through rate, conversion rate, and view time. The dataset is particularly suited for use with evolutionary algorithms such as the Shuffled Frog Leaping Algorithm combined with Dueling Deep Q-Networks to optimize ad dissemination strategies. The primary target variable, ROI_Category, categorizes return on investment into Low, Medium, and High, helping advertisers refine their content strategies.

The retail sales dataset provides transactional data that includes sales revenue, units sold, discount percentages, marketing spend, store location, and seasonal effects. By analyzing these factors, businesses can gain insights into the impact of marketing campaigns, pricing strategies, and holiday trends on overall revenue. This dataset supports various use cases, such as predictive modeling to forecast future sales, marketing analysis to evaluate campaign effectiveness, seasonal trend analysis to understand sales fluctuations, and revenue optimization strategies.

Together, these datasets serve as a powerful tool for businesses seeking to improve ad targeting, enhance sales performance, and optimize marketing expenditures. By integrating insights from both advertising engagement and sales transactions, companies can develop holistic strategies to maximize their return on investment and customer engagement. This dataset provides sales records of alcoholic beverages, including wine, beer, and liquor, from various suppliers for January 2020. Each entry contains details such as the year, month, supplier name, item code, product description, and type of beverage. Additionally, the dataset tracks sales performance through three key metrics: retail sales (units sold directly to customers), retail transfers (items moved between retail locations), and warehouse sales (stock sold from warehouses). Notably, some products have significant warehouse sales but no retail sales, indicating potential inventory stocking or slow retail movement. Among the listed items, certain wines and liquors, such as Knob Creek Bourbon and Cortenova Veneto, show higher retail sales, while others remain primarily in warehouse inventory. The presence of retail transfers for some products suggests that stock is being redistributed across stores to optimize availability.

| | | | ITEM | |
|---|---|---|---|---|
| YEAR | MONTH | SUPPLIER | CODE | ITEM DESCRIPTION |
| 2020 | 1 | REPUBLIC NATIONAL | 100009 | BOOTLEG RED - 750 ML |
| | | DISTRIBUTING CO | | |
| 2020 | 1 | PWSWN INC | 100024 | MOMENT DE PLAISIR - 750 ML |
| 2020 | 1 | RELIABLE CHURCH [symbol] | 1001 | S. SMITH ORGANIC PEAR CIDER - [symbol] |
| 2020 | 1 | LANTERNA DISTRIBUTORS INC | 100145 | SCHLIN [symbol] HAUS KABINETT - 750 ML |
| 2020 | 1 | DIONYSOS IMPORTS INC | 100293 | SANTORINI GAVALA WHITE - 750 ML |
| 2020 | 1 | KYSELA PERE ET FILS LTD | 100541 | CORTENOVA VENETO P/GRIG - 750 ML |
| 2020 | 1 | SANTA MARGHERITA USA INC | 100749 | SANTA MARGHERITA P/GRIG ALTO - 375 ML |
| 2020 | 1 | BROWN-FORMAN BEVERAGES | 1008 | JACK DANIELS COUNTRY COCKTAIL |
| | | WORLDWIDE | | SOUTHERN PEACH - [symbol] |
| 2020 | 1 | JIM BEAM BRANDS CO | 10103 | KNOB CREEK BOURBON 9 YR - 100P - 375 ML |
| 2020 | 1 | INTERNATIONAL CELLARS LLC | 101117 | KSARA CAB - 750 ML |
| 2020 | 1 | HEAVEN HILL DISTILLERIES INC | 10120 | J W DANT BOURBON 100P - 1.75 L |

| | | | | WARE- |
|---|---|---|---|---|
| | ITEM | RETAIL | RETAIL | HOUSE |
| YEAR | TYPE | SALES | TRANSFERS | SALES |
| 2020 | WINE | 0 | 0 | 2 |
| 2020 | WINE | 0 | 1 | 4 |
| 2020 | BEER | 0 | 0 | 1 |
| 2020 | WINE | 0 | 0 | 1 |
| 2020 | WINE | 0.82 | 0 | 0 |
| 2020 | WINE | 2.76 | 0 | 6 |
| 2020 | WINE | 0.08 | 1 | 1 |
| 2020 | BEER | 0 | 0 | 2 |
| 2020 | LIQUOR | 6.41 | 4 | 0 |
| 2020 | WINE | 0.33 | 1 | 2 |
| 2020 | LIQUOR | 1.7 | 1 | 0 |

[symbol]

indicates data missing or illegible when filed

The below table depicts a dataset that provides a comprehensive overview of YouTube video engagement metrics, capturing key performance indicators such as views, likes, dislikes, and comment counts. These metrics help assess audience interaction and response to trending content. The dataset also includes crucial details such as the video's publication date, time frame, trending date, and the country where it was published, offering valuable insights into content virality patterns across different regions. By examining the published day of the week, marketers can identify the optimal timing for video releases to maximize engagement.

Additionally, the dataset allows for an in-depth analysis of public sentiment by comparing the likes-to-dislikes ratio and evaluating viewer responses through comment counts. The inclusion of data on whether comments or ratings were disabled for specific videos further enables researchers to explore how these restrictions impact audience engagement. The dataset also categorizes videos based on their channel and associated tags, aiding in the identification of content trends across different genres.

By leveraging this dataset, marketers can gain actionable insights into emerging content trends, audience preferences, and factors influencing video popularity. It serves as an invaluable asset for researchers, data analysts, and digital marketers aiming to understand trending video patterns, sentiment analysis, and the key metrics driving content virality. The dataset ultimately opens up new possibilities within the digital marketing landscape, providing a data-driven approach to optimizing YouTube content strategies.

| | | trending | | | category | publish_{—} | time_{—} | published_{—} | publish |
|---|---|---|---|---|---|---|---|---|---|
| Index | [symbol] | date | title | channel_title | id | date | frame | day of [symbol] | country |
| 0 | [symbol] | [symbol] | WE WANT TO | [symbol] | [symbol] | [symbol] | [symbol] | Monday | US |
| | | | TALK ABOUT | | | | | | |
| | | | OUR MARRIAGE | | | | | | |
| 1 | [symbol] | [symbol] | The Trump Presidency | LastWeekTonight | [symbol] | [symbol] | [symbol] | Monday | US |
| | | | Last Week Tonight | | | | | | |
| | | | with Tom Oliver [symbol] | | | | | | |
| 2 | [symbol] | [symbol] | [symbol] Superman [symbol] | Rudy Mancuso | [symbol] | [symbol] | [symbol] | Sunday | US |
| | | | [symbol] Mancuso, [symbol] | | | | | | |
| | | | [symbol] | | | | | | |
| 3 | [symbol] | [symbol] | Nickelback Lyrics: | Good [symbol] | [symbol] | [symbol] | [symbol] | Monday | US |
| | | | Real or Fake? | Morning | | | | | |
| 4 | [symbol] | [symbol] | [symbol] | [symbol] | [symbol] | [symbol] | [symbol] | Sunday | US |
| 5 | [symbol] | [symbol] | 2 Weeks with iPhone X | [symbol] | [symbol] | [symbol] | [symbol] | Monday | US |
| 6 | [symbol] | [symbol] | Roy Moore & Jeff Sessions | Saturday Night | [symbol] | [symbol] | [symbol] | Sunday | US |
| | | | Cold Open - SNL | Live | | | | | |
| 7 | [symbol] | [symbol] | [symbol] Cream Gadgets | CrazyRussianHacker | [symbol] | [symbol] | [symbol] | Sunday | US |
| | | | put to the Test | | | | | | |
| 8 | [symbol] | [symbol] | The Greatest Showman: | 20th Century F [symbol] | 1 | [symbol] | [symbol] | Monday | US |
| | | | Official Trailer 2 | | | | | | |
| | | | [symbol] 20th Century FOX | | | | | | |

| | | | | | comment_{—} | comments_{—} | ratings_{—} | video_{—} |
|---|---|---|---|---|---|---|---|---|
| Index | tags | views | likes | dislikes | count | disabled | disabled | [symbol] |
| 0 | [symbol] | [symbol] | [symbol] | [symbol] | [symbol] | FALSE | FALSE | FALSE |
| 1 | [symbol] | [symbol] | [symbol] | [symbol] | [symbol] | FALSE | FALSE | FALSE |
| 2 | [symbol] | [symbol] | [symbol] | [symbol] | [symbol] | FALSE | FALSE | FALSE |
| 3 | [symbol] | [symbol] | [symbol] | [symbol] | [symbol] | FALSE | FALSE | FALSE |
| 4 | [symbol] | [symbol] | [symbol] | [symbol] | [symbol] | FALSE | FALSE | FALSE |
| 5 | [symbol] | [symbol] | [symbol] | [symbol] | [symbol] | FALSE | FALSE | FALSE |
| 6 | [symbol] | [symbol] | [symbol] | [symbol] | [symbol] | FALSE | FALSE | FALSE |
| 7 | [symbol] | [symbol] | [symbol] | [symbol] | [symbol] | FALSE | FALSE | FALSE |
| 8 | [symbol] | [symbol] | [symbol] | [symbol] | [symbol] | FALSE | FALSE | FALSE |

[symbol]

indicates data missing or illegible when filed

The testing deployment module 201D is configured to deploy generated digital creative data alongside original digital creative data for live campaign testing. The testing deployment module 201D is configured to integrate with a set of external advertising platforms via one or more APIs for campaign deployment. Examples of external advertising platforms include Google Ads and Facebook Ads. In additional system embodiments, the testing deployment module 201D is configured to compute a statistical significance of campaign results to determine the performance of regenerated content relative to original content. The testing deployment module 201D is an A/B testing deployment module.

The multimodal generative module 201F is configured to combine insight from textual data, visual data, and behavioral data to identify one or more underperforming live campaigns and generate optimized variations of the set of live campaigns. The multimodal generative module 201F is further configured to evaluate and optimize textual elements of marketing campaigns, including headlines, descriptions, and calls-to-action. The multimodal generative module 201F is further configured to analyze and regenerate creative assets, including images, videos, and layouts, using multimodal insights. The multimodal generative module 201F is further configured to assess user engagement metrics, historical performance data, and audience behavior. The multimodal generative module 201F is further configured to combine insights from text, visuals, and behavioral data to identify underperforming campaign elements and generate optimized variations.

The predictive failure analysis module 201G is configured to identify one or more high-risk campaigns and utilizes a historical performance data to flag the one or more high-risk campaigns based on the performance metric. The predictive failure analysis module 201G is configured to incorporate real-time social sentiment data to adjust campaign strategies. The predictive failure analysis module 201G is configured to use historical performance data to flag high-risk campaigns.

The feedback loop and performance tracking module 201E is configured to monitor the real-time performance data of a set of live campaigns via the one or more APIs. In additional system embodiments, the feedback loop and performance tracking module 201E is configured to identify trends in live campaign data and update a set of generative models to enhance future creative outputs. The feedback loop and performance tracking module 201E is configured to fine-tune the generative models of the content regeneration engine module based on the real-time performance data.

According to some embodiments, each of the components and modules 201A-201E may be embodied in memory 201. The computer processor 203 may retrieve computer program code instructions that may be stored in memory 201 for the execution of computer program code instructions, which may be configured to facilitate data-driven decisions and achieve optimal marketing outcomes.

The computer processor 203 may be embodied in a number of different ways. For example, the computer processor 203 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the computer processor 203 may include one or more processing cores configured to perform independently. A multi-core processor may enable multiprocessing within a single physical package. Additionally, or alternatively, the computer processor 203 may include one or more processors configured in tandem via the bus to enable independent execution of instructions, pipelining, and/or multithreading.

Additionally, or alternatively, the computer processor 203 may include one or more processors capable of processing large volumes of workloads and operations to provide support for big data analysis. In an example embodiment, the computer processor 203 may be in communication with the memory 201 via a bus for passing information to system 101. Memory 201 may be non-transitory and may include, for example, one or more volatile and/or non-volatile memories. In other words, for example, the memory 201 may be an electronic storage device (for example, a computer-readable storage medium) comprising gates configured to store data (for example, bits) that may be retrievable by a machine (for example, a computing device like the computer processor 203). The memory 201 may be configured to store information, data, content, applications, instructions, or the like, to enable the computer processor 203 to carry out various functions in accordance with an example embodiment of the present disclosure. For example, memory 201 may be configured to buffer input data for processing by the computer processor 203. As exemplified in FIG. 2, the memory 201 may be configured to store instructions for execution by the computer processor 203. As such, whether configured by hardware or software methods, or by a combination thereof, the computer processor 203 may represent an entity (for example, physically embodied in circuitry) capable of performing operations according to an embodiment of the present disclosure while configured accordingly. Thus, for example, when the computer processor 203 is embodied as an ASIC, FPGA, or the like, the computer processor 203 may be specifically configured hardware for conducting the operations described herein. Alternatively, as another example, when the computer processor 203 is embodied as an executor of software instructions, the instructions may specifically configure the computer processor 203 to perform the algorithms and/or operations described herein when the instructions are executed. However, in some cases, the computer processor 203 may be a processor-specific device (for example, a mobile terminal or a fixed computing device) configured to employ an embodiment of the present disclosure by further configuration of the computer processor 203 by instructions for performing the algorithms and/or operations described herein. The computer processor 203 may include, among other things, a clock, an arithmetic logic unit (ALU), and logic gates configured to support the operation of the computer processor 203.

The system 101 may be accessed using the communication interface 205 or a user interface. The user interface 205 enables the marketers to: upload creative content and historical data; view real-time campaign performance metrics; and customize the parameters of the content regeneration engine. In an embodiment, the regenerative marketing analytics system 101 is implemented as a cloud-based platform accessible via a web interface. The communication interface 205 may provide an interface for accessing various features and data stored in the regenerative marketing analytics system 101. For example, the communication interface 205 may comprise an I/O interface which may be in the form of a GUI, a touch interface, a voice-enabled interface, a keypad, and the like. In an embodiment, the communication interface 205 may present visual reports or dashboards based on insights and forecasts. Users can create and customize dashboards with various widgets and visualizations, which are updated in real time with the latest data. Interactive visualizations such as charts, graphs, and tables display insights and forecasts. Additionally, the system offers export options to various formats like PDF, Excel, and PowerPoint. Dashboards can be shared with team members, with features for annotations and comments to facilitate sharing and collaboration.

FIG. 2B illustrates an operational flow diagram of the regenerative marketing analytics system, in accordance with one or more example embodiments. FIG. 2B is explained in conjunction with the elements of FIG. 2A. FIG. 2B depicts a frontend dashboard (207), REST API Backend (FastAPI) (209), data storage (AWS S3/Redis) (211), one or more ad platforms (Google Ads, Facebook Ads) (213), creative analysis module (201B), content regeneration engine module (201C), testing deployment module (201D), and feedback loop and performance tracking module (201E). The frontend dashboard (207) is built using React to provide real-time feedback dashboards. The data storage (AWS S3/Redis) (211) utilizes AWS S3 or Google Cloud Storage to store both structured and unstructured campaign data. The ad platforms (213) (e.g., Google Ads, Facebook Ads) are connected to the testing deployment module (201D) and the feedback loop and performance tracking module (201E) to facilitate real-time monitoring and adjustments. The system is designed to collect and integrate data from multiple sources to monitor campaign performance effectively. It connects to ad platforms such as Google Ads, Facebook Ads, and email tools via APIs to ingest campaign metrics, including Click-Through Rate (CTR), Cost Per Click (CPC), engagement rates, conversions, and impressions. Additionally, the system uploads creative assets (e.g., images, videos, ad copy) for analysis and integrates historical campaign data to perform trend analysis, enhancing its predictive capabilities and optimizing ad performance over time.

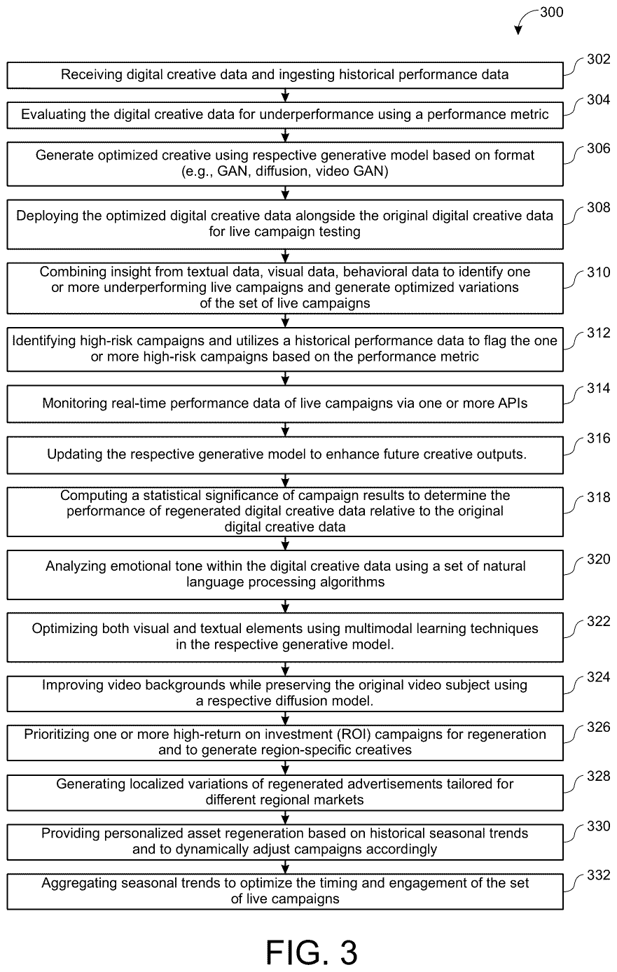

FIG. 3 illustrates a flowchart of a computer-implemented method 300 for regenerative marketing analytics, in accordance with one or more example embodiments. FIG. 3 is explained in conjunction with FIGS. 1-2. The method 300 includes a step 302 of receiving, by a computer, digital creative data and ingesting historical performance data. The method 300 includes a step 304 of evaluating, by the computer, the digital creative data for underperformance using a performance metric. The method 300 includes a step 306 of generating, by the computer, optimized digital creative data using one or more of a set of generative adversarial networks (GANs), a set of diffusion models, and a set of video GANs. Method 300 includes a step 308 of deploying, by the computer, the optimized digital creative data alongside the original digital creative data for live campaign testing. Method 300 includes a step 310 of combining, by the computer, insight from textual data, visual data, and behavioral data to identify one or more underperforming live campaigns and generate optimized variations of the set of live campaigns. Method 300 includes a step 312 of identifying, by the computer, one or more high-risk campaigns and utilizes a historical performance data to flag the one or more high-risk campaigns based on the performance metric. Method 300 includes step 314 of monitoring, by the computer, real-time performance data of live campaigns via one or more APIs. Method 300 includes step 316 of identifying, by the computer, trends in live campaign data and updating the set of generative models to enhance future creative outputs. Method 300 includes step 318 of computing, by the computer, a statistical significance of campaign results to determine the performance of regenerated digital creative data relative to the original digital creative data. Method 300 further includes a step 320 of analyzing, by the computer, emotional tone within the digital creative data using a set of natural language processing algorithms. Further, method 300 includes a step 322 of optimizing, by the computer, both visual and textual elements of the digital creative data using multi-modal learning techniques in the set of generative models. Method 300 includes a step 324 of improving, by the computer, video backgrounds while preserving the original video subject using diffusion models. Method 300 includes a step 326 of prioritizing, by the computer, one or more high-return on investment (ROI) campaigns for regeneration and generating region-specific creatives comprising localized visuals, text, and cultural preferences. Method 300 further includes a step 328 of generating, by the computer, localized variations of regenerated advertisements tailored for different regional markets. The method 300 includes a step 330 of providing, by the computer, personalized asset regeneration based on historical seasonal trends and dynamically adjusting campaigns accordingly. Method 300 includes step 332 of aggregating, by the computer, seasonal trends to optimize the timing and engagement of the set of live campaigns.

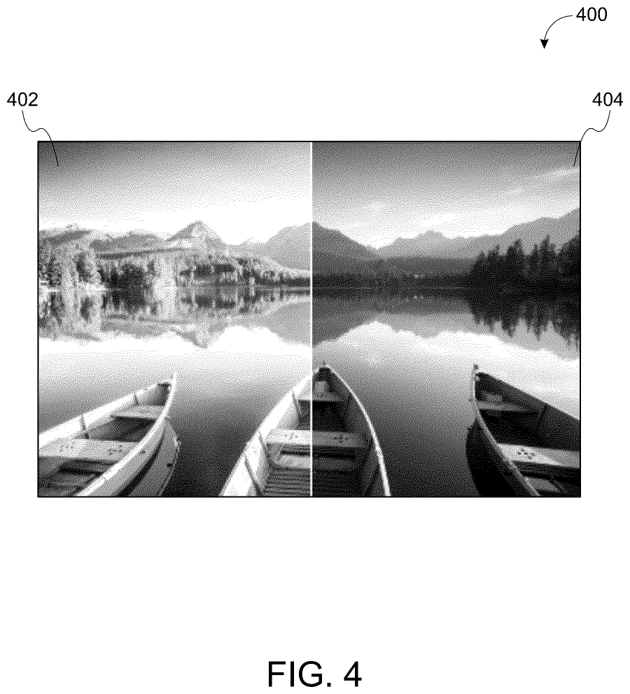

FIG. 4 illustrates a before-and-after image 400 of regenerated creatives based on dataset insights, in accordance with one or more example embodiments. The content regeneration engine module 201C is responsible for modifying an initial before image 402 into an after image 404 with enhanced visual properties. Brightness adjustments play a key role in improving the visual appeal and effectiveness of the ad.

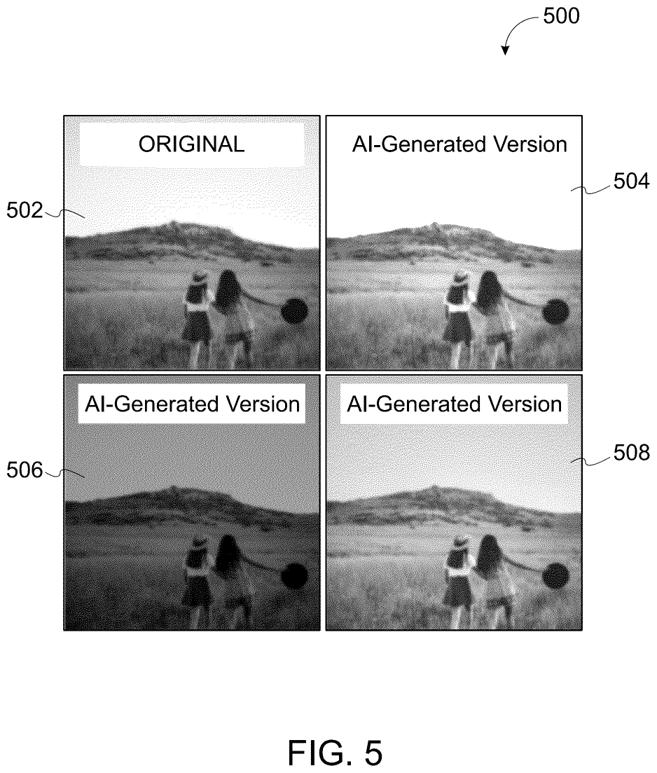

FIG. 5 illustrates an image series 500 of incremental brightness changes 502, 504, 506, and 508, in accordance with one or more example embodiments. One of the primary methods used for brightness adjustment is incremental brightness scaling, as demonstrated in FIG. 5. The image series 500 showcases brightness changes at different levels: original image (No Change) 502; AI-generated version (increased exposure: +50) 504, AI-generated version (Decreased Exposure: −75) 506, and AI-generated version (Optimized Brilliance: +80) 508. Thus, the content regeneration engine module 201C dynamically generates optimized creative variations, such as exposure adjustments (+50, −70) and brilliance enhancements (+80), using AI-driven analysis based on historical engagement data and real-time performance feedback. This approach allows controlled experimentation with brightness variations to optimize visual impact. Beyond simple scaling, advanced algorithmic adjustments such as histogram equalization are employed to dynamically enhance contrast and balance brightness. This method analyzes pixel intensity distribution and redistributes brightness levels to ensure a well-balanced exposure. Contrast-Limited Adaptive Histogram Equalization (CLAHE) is another technique used to prevent over-brightening, applying localized contrast adjustments while preserving important image details.

Machine learning plays a crucial role in adaptive brightness correction by analyzing datasets of successful creatives and dynamically adjusting brightness to match patterns associated with higher engagement. AI-driven models optimize brightness settings based on the ad's intended audience, platform, and content type, ensuring that visuals are tailored for maximum impact.

Another sophisticated approach is gamma correction, which optimizes perceived brightness to align with human visual perception. Adjusting the gamma curve ensures that brightness changes appear natural rather than artificially enhanced, maintaining aesthetic appeal across different viewing environments.

The content regeneration engine module 201C likely employs proprietary techniques such as dataset-driven brightness mapping, which analyzes engagement trends to set optimal brightness levels. Additionally, real-time adaptive tuning may be implemented to adjust brightness dynamically based on ambient lighting conditions or user preferences. AI-based reinforcement learning can further fine-tune brightness settings based on past creative performance, ensuring continuous improvement.

By leveraging incremental brightness scaling, histogram-based adjustments, AI-driven optimizations, and proprietary tuning techniques, the system ensures that ad creatives are visually compelling and optimized for engagement. These brightness adjustments refine composition, improve visibility, and enhance the creative's overall effectiveness across different viewing conditions and target audiences.

According to an embodiment herein, the present invention provides a computer program product for regenerative marketing analytics. The computer program product includes one or more computer-readable storage media; and program instructions stored on the one or more computer-readable storage media to perform operations comprising: receiving digital creative data and ingesting historical performance data; evaluating the digital creative data for underperformance using a performance metric; generating optimized digital creative data using one or more of a set of generative adversarial networks (GANs), a set of diffusion models, and a set of video GANs; deploying the optimized digital creative data alongside the original digital creative data for live campaign testing; combining insight from textual data, visual data, behavioral data to identify one or more underperforming live campaigns and generate optimized variations of the set of live campaigns; identifying one or more high-risk campaigns and utilizes a historical performance data to flag the one or more high-risk campaigns based on the performance metric; and monitoring real-time performance data of live campaigns via one or more APIs.

According to an embodiment, the present disclosure relates to a regenerative marketing analytics system that applies artificial intelligence (AI)-powered modifications to digital advertising creatives. The system utilizes deep learning models, such as generative adversarial networks (GANs) and diffusion models, to enhance image clarity, text legibility, and visual impact. It dynamically refines video advertisements by adjusting motion pacing, call-to-action overlays, and key visual frames to maximize audience engagement. A content adaptation engine regenerates ad creatives based on A/B testing results and real-time feedback loops.

The system continuously analyzes historical ad performance, seasonal trends, and real-time engagement data to optimize marketing creatives dynamically. Since generic image datasets do not contain structured advertising data, the system relies on industry-specific datasets for AI training and model fine-tuning. For example, the Google Ads Search Performance Dataset enables the system to analyze past ad performance and generate optimized creative variations to improve click-through rates (CTR) and audience engagement. The Seasonal Consumer Trends Dataset allows AI-driven adjustments based on historical seasonal engagement data, ensuring campaign optimization throughout the year. Additionally, the Global Advertising Dataset facilitates localization by adapting marketing creatives for different geographic markets.

The system leverages structured datasets containing real-world advertising performance metrics to train its content regeneration engine. Examples include: 1. Google Ads Search Performance Dataset—Contains historical Google Ads metrics, including CTR, cost per click (CPC), impressions, and conversions. The system identifies underperforming creatives and regenerates ad elements such as copy, visuals, and targeting. 2. YouTube Ad Engagement Dataset—Provides engagement metrics for video ads, including watch time, interaction rates, and audience retention data. The system optimizes video ad regeneration by modifying scene pacing, overlay text, and call-to-action placements based on past engagement performance. 3. Seasonal Consumer Trends Dataset—Captures consumer purchasing behavior across different seasons, enabling brands to dynamically adjust ad creatives for peak engagement periods, such as holiday promotions and back-to-school campaigns. 4. Global Advertising Dataset—Contains advertising performance data across multiple regions, allowing the system to generate localized ad variations by adjusting product imagery, language, and cultural references based on geographic engagement trends.

The present disclosure further describes various use case examples of the regenerative analytics system, demonstrating its adaptability across multiple industries.

In the e-commerce sector, particularly for retail and direct-to-consumer (DTC) brands, ad creatives often lose effectiveness after a few weeks. The regenerative analytics system addresses this issue by dynamically regenerating images, call-to-action overlays, and ad copy based on real-time engagement trends. This continuous optimization ensures that advertisements maintain high performance over time, thereby maximizing return on investment.

For streaming services operating within entertainment and subscription platforms, video ads often suffer from a short attention span, leading to low conversion rates. To mitigate this challenge, the system utilizes AI-driven regeneration techniques to dynamically adjust scene pacing, overlays, and keyframes. These real-time optimizations enhance ad visuals, improving watch time and overall engagement with the content.

In the financial services industry, including fintech and banking advertisements, static display and banner ads tend to become repetitive, resulting in reduced click-through rates (CTR).

The regenerative analytics system overcomes this limitation by automatically modifying banner design, call-to-action placement, and color schemes based on user engagement data. This approach ensures that financial ads remain visually appealing and relevant, thereby improving user interaction and conversion rates. By leveraging AI-driven regenerative analytics, the system continuously refines ad creatives across various industries, enhancing engagement, retention, and conversion outcomes.

In operation, the system refines regenerated ad creatives through real-time campaign feedback loops and AI-driven performance analysis. A testing deployment module conducts A/B tests, comparing regenerated creatives to original versions based on key performance indicators such as CTR, CPC, conversions (Google Ads Search Performance Dataset), and engagement rates (YouTube Ad Engagement Dataset). If a regenerated creative outperforms the original, the system scales the improved version for full deployment and refines AI parameters for future content generation. If no improvement is detected, the system further modifies the design, messaging, or visual structure and adjusts targeting recommendations using audience insights from historical campaign data.

The system ensures that regenerated ad creatives are automatically adapted for multiple digital formats, including search ads, display ads, social media campaigns, email marketing, and video ads. By leveraging datasets such as the Global Advertising Dataset, the system tailors ad creatives for different platforms and audiences. This AI-driven approach ensures continuous optimization, responsiveness, and adaptation based on historical insights, real-time performance, and consumer behavior trends.

Prior to implementing a regenerative analytics system, a tech company launched a Google Ads campaign with high cost-per-click (CPC) rates. After running the campaign for two weeks, performance data revealed poor conversion rates. However, adjustments to improve the campaign required manual intervention, resulting in delays of several days. By contrast, with the present invention's (commercialized as Japio's product) regenerative analytics system, underperforming keywords were identified, and the ad copy and targeting were dynamically regenerated. As a result, CPCs decreased by 30%, and conversion rates improved by 45% within 24 hours.

The present invention addresses a key problem faced by marketers: AI-generated content does not always perform as expected, and current tools cannot regenerate or optimize campaigns in real-time. This system solves the problem by utilizing performance data to dynamically regenerate campaigns, improving elements such as ad copy, visuals, and targeting based on real-time metrics. For example, if a marketer launches an underperforming Facebook ad, the system can automatically adjust the creative assets and ad copy, resulting in increased conversions.

Current trends in artificial intelligence extend beyond content creation, incorporating real-time analysis to detect areas for improvement and regenerate content or strategies dynamically based on performance. The present invention uses artificial intelligence to automatically regenerate campaigns using feedback loops from prior marketing efforts. For instance, the system may iteratively refine ad campaigns or digital content using predictive analytics, thereby improving return on investment (ROI).

This regenerative marketing analytics system delivers substantial business benefits, including real-time campaign adjustments to ensure continuous improvement, efficiency gains by automating the identification of underperforming campaigns, and cost savings through dynamic budget reallocation. For example, the system analyzes key performance indicators (KPIs) such as click-through rates (CTR), CPC, and ROI in real time and reallocates advertising spending to high-performing platforms. Additionally, the system dynamically regenerates content, suggesting improved visuals or messaging to enhance engagement.

The regenerative marketing analytics system's impact is evident in scenarios such as event promotion and e-commerce campaigns. In an event promotion campaign, an underperforming webinar ad with irrelevant messaging was regenerated by AI, resulting in a 15% increase in sign-ups. Similarly, during an e-commerce flash sale, when campaign CTRs dropped midway, the system dynamically adjusted messaging to emphasize “final hours,” increasing sales by 10%. These examples illustrate how the system ensures continuous improvement in campaign performance.

The regenerative marketing analytics system transforms digital marketing campaigns by enabling continuous improvement throughout their lifecycle and empowering marketers to make dynamic decisions based on real-time performance changes. It automates tasks such as segmentation, A/B testing, and optimization, allowing marketers to focus on strategy. Direct integration with ad platforms ensures that insights and regenerated assets can be applied instantly, streamlining the process further.

In operation, the present regenerative marketing analytics system operates through five key steps: 1. Performance Monitoring: A real-time KPI dashboard displays campaign metrics such as CTR, CPC, and ROI, with underperforming areas highlighted for quick identification. 2. Automated Regeneration: Marketers can click a “Regenerate” button to optimize ads. For example, the system might suggest an alternative call-to-action (CTA) or updated visuals to boost engagement. 3. Suggested Adjustments: A regeneration suggestions panel provides actionable recommendations, such as replacing a headline with “Last Chance Sale!” to achieve a 10% CTR increase or using brighter colors to enhance visual appeal. 4. Performance Tracking: A regeneration impact panel tracks improvements in real-time, showing metrics such as an 8% increase in CTR after implementing suggested changes. 5. Platform Integration: Marketers can directly export regenerated campaign assets to their advertising platforms, enabling seamless application of the optimizations.

According to some embodiments of the present invention, a regenerative marketing analytics system is provided for dynamically regenerating marketing campaigns using generative AI, and real-time performance analytics is described. The system comprises a campaign performance analysis module that identifies underperforming elements within campaigns. A content regeneration engine then creates updated marketing assets, including visuals and textual content, to improve campaign effectiveness. Additionally, a redeployment module implements the updated campaign elements across multiple ad formats and platforms, ensuring seamless integration and optimization. The method for regenerating and optimizing marketing campaigns involves analyzing performance data to identify inefficiencies or underperforming areas. Based on this analysis, generative AI generates new marketing content tailored to address identified weaknesses, such as updated visuals or textual assets. Once regenerated, the updated campaigns are redeployed to targeted platforms, ensuring improvements are promptly implemented and measurable. To enhance the targeting aspect of marketing campaigns, a system is disclosed for automating the regeneration of targeting parameters. This system includes a targeting analysis module to evaluate audience segmentation effectiveness, a regeneration engine to adjust targeting parameters dynamically, and an optimization module that refines targeting strategies through iterative feedback and predictive analytics. These features ensure the campaigns are constantly adapted to achieve better engagement and reach the intended audience effectively.

Another aspect of the system focuses on predicting and preventing campaign underperformance using regenerative marketing analytics. According to some embodiment of the present invention, the regenerative marketing analytics system may include a predictive failure analysis module that uses historical and real-time performance data to flag high-risk campaigns. A content adjustment engine then suggests and implements corrective actions, such as alternative visuals, messaging, or targeting strategies. A monitoring dashboard provides real-time updates on recovery outcomes, enabling marketers to track improvements and make informed decisions to maximize campaign ROI.

According to some embodiments of the present invention, a computer-readable medium storing instructions for analyzing, regenerating, and optimizing marketing campaigns is provided. These instructions facilitate various functions, such as campaign performance monitoring, content regeneration, and redeployment across platforms. The stored instructions also include templates for generating and optimizing content for different formats, such as display ads, video ads, and social media posts, ensuring compatibility and effectiveness across diverse channels.

According to some embodiments of the present invention, the regenerative marketing analytics system may include a campaign performance analysis module that can identify underperforming elements, such as banner ads, based on benchmarks like click-through rates (CTR). The content regeneration engine supports creating localized, multilingual, or seasonal variations of regenerated content to cater to specific regional or temporal market needs. The redeployment module integrates seamlessly with third-party platforms, such as Google Ads and Facebook Ads, for direct updates and supports features like A/B testing and scheduling based on audience activity patterns. The method for regenerating and optimizing campaigns includes analyzing key performance indicators (KPIs) such as CTR, conversion rates, cost-per-acquisition, and bounce rates. Based on this analysis, generative AI produces tailored messaging and visuals for segmented audiences. These regenerated campaigns are redeployed with platform-specific adjustments, ensuring maximum effectiveness. Additional features include automated A/B testing, seasonal updates, and geotargeting regenerated ads to specific regions to enhance audience relevance.

According to some embodiments of the present invention, the regenerative marketing analytics system may include a targeting analysis module that identifies underperforming audience segments, while the regeneration engine adjusts targeting parameters to explore new audience clusters. A predictive model forecasts audience behavior trends, allowing the optimization module to prioritize high-value customer segments and refine targeting strategies. A visualization dashboard provides insights into audience segmentation effectiveness, enabling marketers to make data-driven decisions.

To prevent campaign underperformance, the predictive failure analysis module identifies potential issues using historical and real-time data. The content adjustment engine then provides actionable recommendations, such as modifying visuals, messaging, or calls to action. A real-time alert system notifies marketers of high-risk campaigns, while the monitoring dashboard visualizes recovery metrics like engagement rates and cost-per-click improvements. The system integrates competitor benchmarks and audience segmentation strategies to ensure campaigns remain competitive and effective. The computer-readable medium further supports campaign optimization by storing instructions for creating content templates, analyzing performance metrics, and regenerating campaign elements. It enables the automation of tasks such as A/B testing, seasonal content updates, and geotargeting. Additionally, the stored instructions facilitate mobile-first optimization, predictive modeling, and integration with third-party analytics platforms for real-time performance monitoring.

Thus, the present regenerative marketing analytics system transforms marketing campaigns by enabling dynamic adjustments, predictive analytics, and automated content regeneration. It addresses underperformance in real-time, ensures audience relevance, and enhances ROI through iterative optimization, making it a comprehensive solution for modern marketing challenges. Further, the present regenerative marketing analytics system may use AI-driven predictive models, including GANs and diffusion models, to anticipate a decline in CTR for video ads and proactively adjust content to maximize engagement. By analyzing historical ad performance, real-time user interactions, and external factors such as seasonal trends or market shifts, the system identifies early indicators of declining engagement. Key metrics like dwell time, engagement drop-off, and interaction rates signal potential performance issues, prompting the system to intervene dynamically. Furthermore, to counteract declining CTR, the system reconfigures the first three seconds of the video ad, the most crucial window for capturing audience attention. GANs and Video GANs may regenerate keyframes by optimizing visual appeal, motion pacing, and text overlays to ensure that the opening moments immediately engage the viewer. For instance, if the model predicts that an ad's current introduction lacks impact, it may replace static product imagery with a high-energy, user-generated testimonial or a dynamic product demonstration. Meanwhile, diffusion models enhance lighting, background clarity, and focal elements, ensuring that regenerated video intros are more visually compelling and aligned with audience preferences.

Another advantage of the present system is its ability to seamlessly integrate optimized creatives across multiple ad formats to ensure consistency across search ads, social media campaigns, and email marketing. When a video ad undergoes dynamic adjustments, the system simultaneously refines static ad formats such as banner images in display ads, carousel creatives for social media, and personalized email previews to reflect the updated video's key message and aesthetics. This cross-channel adaptability ensures that every touchpoint reinforces a cohesive brand narrative, increasing conversion potential across different marketing channels. Additionally, the system continuously performs A/B test variations in real-time, using engagement feedback to fine-tune subsequent adjustments. By automating this process, brands can optimize their campaigns without manual intervention, reducing creative fatigue while maximizing ROI on ad spend.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A regenerative marketing analytics system, comprising:
a memory for storing program instructions;
a computer processor coupled to the memory and executing the program instructions, wherein the memory comprises:
a creative performance analytics module configured to receive digital creative data and ingest historical performance data;
a creative evaluation module configured to identify underperformance based on one or more predefined performance metrics;
a content regeneration engine configured to generate optimized digital creative content using a respective generative model selected from among generative adversarial networks (GANs), diffusion models, or video GANs, based on the format of the original content, wherein the content regeneration engine is further configured to modify the digital creative content at a pixel level by performing at least one of brightness scaling, histogram-based adjustment, contrast-limited adaptive histogram equalization (CLAHE), gamma correction, diffusion-based background refinement while preserving one or more of: an original video subject, a text overlay enhancement, and a video pacing modification;
a deployment module configured to serve both regenerated and original creative content for A/B testing across digital advertising platforms;
a performance tracking module configured to monitor live engagement and conversions via advertising platform APIs; and
a feedback loop module configured to use performance results to influence future regeneration decisions, wherein the feedback loop module is further configured to update one or more parameters of the respective generative model based on a received real-time performance data to iteratively refine subsequent regenerated digital creative content.

2. The regenerative marketing analytics system of claim 1, wherein the feedback loop and performance tracking module is configured to identify trends in live campaign data and update a set of generative models to enhance future creative outputs.

3. The regenerative marketing analytics system of claim 1, wherein the testing deployment module is configured to compute a statistical significance of campaign results to determine the performance of regenerated content relative to original content.

4. The regenerative marketing analytics system of claim 1, wherein the creative analysis module is further configured to analyze emotional tone based on a set of natural language processing algorithms.

5. The regenerative marketing analytics system of claim 1, wherein the set of generative models of the content regeneration engine module incorporate multi-modal learning to simultaneously optimize visual and textual elements.

6. The regenerative marketing analytics system of claim 1, wherein the content regeneration engine module applies diffusion models to improve video backgrounds while preserving the original video subject.

7. The regenerative marketing analytics system of claim 1, wherein the creative analysis module is configured to prioritize one or more high-return on investment (ROI) campaigns for regeneration and to generate region-specific creatives comprising localized visuals, text, and cultural preferences.

8. The regenerative marketing analytics system of claim 1, wherein the content regeneration engine module is configured to generate localized variations of regenerated advertisements tailored for different regional markets.

9. The regenerative marketing analytics system of claim 1, wherein the content regeneration engine module is configured to provide personalized asset regeneration based on historical seasonal trends and to dynamically adjust campaigns accordingly.

10. The regenerative marketing analytics system of claim 1, wherein the content regeneration engine module is configured to aggregate seasonal trends to optimize the timing and engagement of the set of live campaigns.

11. A computer-implemented method, comprising:
receiving, by a computer, digital creative data and ingesting historical performance data;
evaluating, by the computer, the digital creative data for underperformance using a performance metric;
generating, by the computer, optimized digital creative data using a respective generative model selected from among generative adversarial networks (GANs), diffusion models, and video GANs, based on the content format;
modifying, by the computer, the digital creative content at a pixel level by performing at least one of brightness scaling, histogram-based adjustment, contrast-limited adaptive histogram equalization (CLAHE), gamma correction, diffusion-based background refinement while preserving one or more of: an original video subject, a text overlay enhancement, and a video pacing modification;
deploying, by the computer, the optimized digital creative data alongside the original digital creative data for live campaign testing;
combining, by the computer, insight from textual data, visual data, and behavioral data to identify one or more underperforming live campaigns and generate optimized variations of the live campaigns;
identifying, by the computer, one or more high-risk campaigns and utilizing historical performance data to flag the one or more high-risk campaigns based on the performance metric;
monitoring, by the computer, real-time performance data of live campaigns via one or more APIs; and
updating, by the computer, one or more parameters of the respective generative model based on a received real-time performance data to iteratively refine subsequent regenerated digital creative content.

12. The computer-implemented method of claim 11, further comprising:
identifying, by the computer, trends in live campaign data and updating the set of generative models to enhance future creative outputs; and
computing, by the computer, a statistical significance of campaign results to determine the performance of regenerated digital creative data relative to the original digital creative data.

13. The computer-implemented method of claim 11, further comprising:
analyzing, by the computer, emotional tone within the digital creative data using a set of natural language processing algorithms;
optimizing, by the computer, both visual and textual elements of the digital creative data using multi-modal learning techniques in the set of generative models; and
improving, by the computer, video backgrounds while preserving the original video subject using diffusion models.

14. The computer-implemented method of claim 11, further comprising:
prioritizing, by the computer, one or more high-return on investment (ROI) campaigns for regeneration and generating region-specific creatives comprising localized visuals, text, and cultural preferences.

15. The computer-implemented method of claim 11, further comprising:
generating, by the computer, localized variations of regenerated advertisements tailored for different regional markets;
providing, by the computer, personalized asset regeneration based on historical seasonal trends and to dynamically adjusting campaigns accordingly; and
aggregating, by the computer, seasonal trends to optimize the timing and engagement of the set of live campaigns.

16. A computer program product for regenerative marketing analytics, the computer program product comprising:
one or more computer-readable storage media; and
program instructions stored on the one or more computer-readable storage media to perform operations comprising:
receiving digital creative data and ingesting historical performance data;
evaluating the digital creative data for underperformance using a performance metric;
generating optimized digital creative data using a respective generative model selected from among GANs, diffusion models, or video GANs, based on the content type;
modifying the digital creative content at a pixel level by performing at least one of brightness scaling, histogram-based adjustment, contrast-limited adaptive histogram equalization (CLAHE), gamma correction, diffusion-based background refinement, while preserving one or more of: an original video subject, a text overlay enhancement, and a video pacing modification;
deploying the optimized digital creative data alongside the original digital creative data for live campaign testing;
combining insight from textual data, visual data, and behavioral data to identify one or more underperforming live campaigns and generate optimized variations;
identifying one or more high-risk campaigns and utilizing historical performance data to flag them based on the performance metric;
monitoring real-time performance data of live campaigns via one or more APIs; and
updating one or more parameters of the respective generative model based on a received real-time performance data to iteratively refine subsequent regenerated digital creative content.
